(19) United States
(12) Patent Application Publication
(10) Pub. No.: US 2026/0003252 A1
(43) Pub. Date: Jan. 1, 2026

(54) CAMERA CASES FOR IMPROVED VEHICLE PHOTOGRAPHY

(71) Applicant: Carvana IPHC, LLC, Tempe, AZ (US)

(72) Inventors: Davo Scheich, Tempe, AZ (US); Brian Srock, Tempe, AZ (US); Bruce Moehl, Tempe, AZ (US); Daniel Stelly, Tempe, AZ (US); Charles Veneklase, Tempe, AZ (US)

(73) Assignee: Carvana IPHC, LLC, Tempe, AZ (US)

(21) Appl. No.: 18/756,871

(22) Filed: Jun. 27, 2024

(51) Int. Cl. G03B 17/56

(52) U.S. Cl. CPC G03B 17/561; G03B 17/566

(57) ABSTRACT

A camera case for capturing a desired angle of an object, the camera case can comprise a support stand comprising a first segment and a second segment, wherein the first segment and the second segment are hingedly coupled, a housing coupled to a first surface of the first segment, wherein the housing can be configured to hold a camera, and wherein the support stand is moveable from a closed position to an open position by rotating the first segment relative to the second segment from a first position to a second position wherein, when in the open position, the second segment is configured to rest on the surface.

### FIELD

The present invention in general relates to a system for photographing vehicles, and, in particular, to camera case configured to consistently position a camera at a desired angle for capturing images of an object.

### BACKGROUND

Capturing images at a consistent desired angle to produce a standardized aesthetic across a class of objects can be tedious and time consuming. A photographer generally must set up and take down their camera staging as new objects are to be captured. This can lead to minor unintentional adjustments to the angles at which the objects are captured, leading to inconsistency across the class of objects. Additionally, even a photographer perfectly arranges their camera staging to capture each image, considerable time is lost between photoshoots. Therefore, there is a need for standardized and efficient devices and methods for capturing images at a uniform angle.

### SUMMARY

In various embodiments, a camera case for capturing a desired angle of an object is provided, the camera case can comprise a support stand comprising a first segment and a second segment, wherein the first segment and the second segment are hingedly coupled, a housing coupled to a first surface of the first segment, wherein the housing can be configured to hold a camera, and wherein the support stand is moveable from a closed position to an open position by rotating the first segment relative to the second segment from a first position to a second position, wherein the second position is in a range of about 20° to about 22.5° away from a line normal to a surface, and wherein, when in the open position, the second segment is configured to rest on the surface.

In various embodiments, the first position is at about 90° away from the line normal to the surface. In various embodiments, when the support stand is in the open position, the camera can capture a perspective angle of an object. In various embodiments, the perspective angle is an underbody angle of the vehicle. In various embodiments, the camera comprises a mobile electronic device. In various embodiments, the object is a vehicle.

In various embodiments, the first segment further comprises a first end and a second end, wherein the second end terminates in a concave flange configured to securely brace the housing. In various embodiments, the second segment further comprises a first end and a second end, wherein the second end terminates in a hook configured to removably fasten to the first end of the first segment when the support stand is in the closed position.

In various embodiments, a method for using a camera case is provided, the method comprising moving a support stand from a closed position to an open position, the support stand comprising: a first segment hingedly coupled to a second segment, wherein the first segment is configured to move relative to the second segment to achieve the open position from the closed position, and wherein when the support stand is in the open position, the first segment is in a range of about 20° to about 22.5° away from a line normal to a surface and the second segment is configured to rest on the surface, placing a camera into a housing, wherein the housing is coupled to a first surface of the first segment, and capturing a perspective angle of an object via the camera.

In various embodiments, a method of constructing a camera case is provided, the method comprising hingedly coupling a first segment of a support stand to a second segment of the support stand, wherein the first segment is configured to rotate relative to the second segment to move between a closed position of the support stand and an open position of the support stand, and wherein when the support stand is in the open position, the first segment is in a range of about 20° to about 22.5° away from a line normal to a surface and the second segment is configured to rest on the surface, and coupling a housing to a first surface of the first segment, wherein the housing is configured to hold a camera. In various embodiments, when the support stand is in the open position, the camera can capture a perspective angle of an object.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a side view of the camera case wherein the support stand is in the open position; and

FIG. 2 is a side view of the camera case wherein the support stand is in the closed position.

### DETAILED DESCRIPTION

There are many instances where standardized photographical configuration across a class of objects may be desirable. For example, when consumers are viewing multiple variations of the same product—such as different colors or styles in clothing, jewelry, or automobiles—having consistent image views and angles allows for direct comparison between variations in the products. In a particular example, automobile dealerships may wish to capture similar images of multiple vehicles in their inventory to allow potential buyers to view and compare the same structure of each vehicle. However, without the use of specialized photography equipment, such as permanently secured cameras or specialty lenses, standard camera configurations are prone to user error during setup, thereby leading to unintentional angles and inconsistent photos. Further, such specialized equipment can be costly, inconvenient to adjust, and inefficient for quick and spontaneous photography shoots. There is therefore a need for an efficient, consistent, and portable camera configuration that allows for standardized photographs of a variety of objects. Embodiments of methods and devices are described below that may be used to capture a standardized photographical configuration across a class of objects.

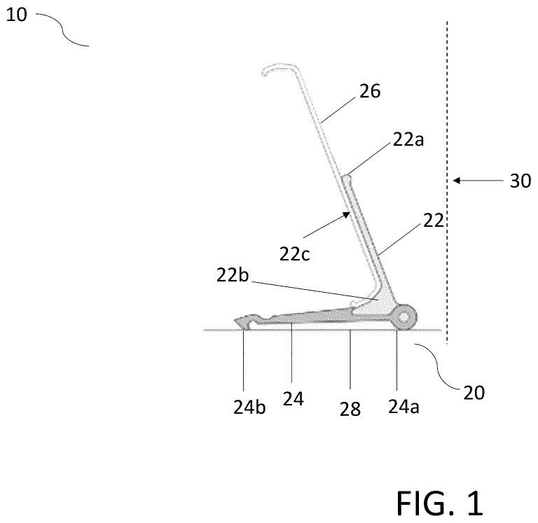

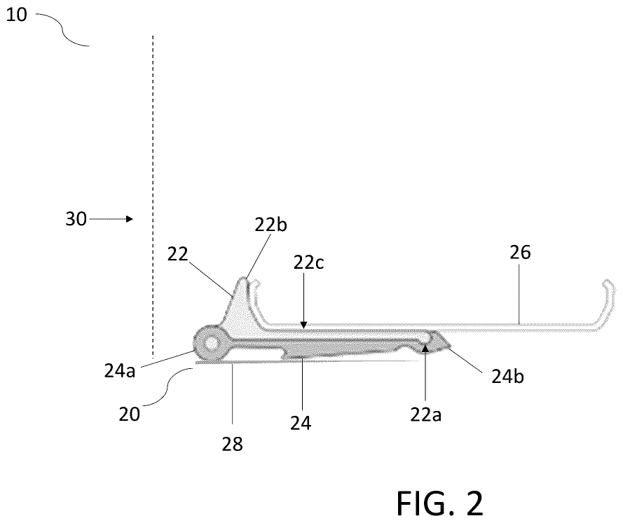

Referring now to the figures, embodiments of a camera case are shown generally in FIGS. 1 and 2. FIG. 1 shows a camera case 10 which includes support stand 20 in an open position. While an embodiment of the open position is shown in FIG. 1, an open position can comprise any position in which the camera case is angled to photograph a subject (e.g., an undercarriage of an automobile). For example, rotational motion of first segment 22 or second segment 24 can be arrested as a more obtuse or a more acute angle and still be considered to be in an open position. Support stand 20 has a first segment 22 and a second segment 24. First segment 22 has a first end 22a and a second end 22b and second segment 24 has a first end 24a and a second end 24b. In various embodiments, first segment 22 further includes a first surface 22c. First segment 22 is connected to second segment 24 in any way sufficient to allow support stand 20 to move between a closed and the open position. Second end 22b of first segment 22 can be connected to second end 24b of second segment 24. In various embodiments, first segment 22 and second segment 24 are coupled in any way sufficient to allow first segment 22 to move relative to second segment 24. In various embodiments, first segment 22 and second segment 24 are coupled by a hinge 32. In various embodiments, hinge 32 may be comprised of any mechanical object or combination of mechanical objects sufficient to produce a hinged and/or rotational motion, such as, for example, heat-set inserts and headless shoulder screws.

In various embodiments, support stand 20 further includes a housing 26. In various embodiments, housing 26 is coupled to first surface 22c of first segment 22. Housing 26 is configured to hold a camera (not shown). In various embodiments, the camera comprises any device configured to capture an image of an object, such as, for example, a digital camera or a mobile electronic device. In various embodiments, housing 26 is coupled to first surface 22c of first segment 22 in any way sufficient to allow housing 26 to support the camera, such as, for example, by adhesive. In various embodiments, second end 22b of first segment 22 may be configured to securely brace housing 26. In various embodiments, second end 22b of first segment 22 may be configured as a concave flange.

As shown in FIG. 1, when support stand 22 is in the open position, first segment 22 is in a range of about 15° to about 30° away from a line 30 normal to surface 28. In many embodiments, first segment 22 is in a range of about 18° to about 25° away from the line 30 normal to surface 28. In further embodiments, first segment 22 is in a range of about 20° to about 22.5° away from the line 30 normal to surface 28. In various embodiments, when support stand 22 is in the open position, second segment 24 is about 90° away from the line 30 normal to surface 28 and is configured to rest on surface 28.

In various embodiments, when support stand 22 is in the open position, the camera can capture a perspective angle of an object (not shown). In various embodiments, the object can be a vehicle. In various embodiments, the perspective angle can be an underbody angle of a vehicle. In various embodiments, when support stand 22 is in the open position, the camera is constrained to only capture the perspective angle, ensuring that every photo taken has identical orientation and staging.

FIG. 2 shows an embodiment of camera case 10 wherein support stand 20 is in the closed position. While an embodiment of the closed position is shown in FIG. 2, a closed position can comprise any position in which the camera case is angled to not photograph a subject (e.g., an undercarriage of an automobile) and/or angled for storage or transport of the camera case. For example, rotational motion of first segment 22 or second segment 24 can be arrested as a more obtuse or a more acute angle and still be considered to be in the closed position. In various embodiments, both first segment 22 and second segment 24 are about 90° away from the line 30 normal to surface 28 and are parallel relative to each other. In various embodiments, first end 24a of second segment 24 terminates in a hook configured to removably fasten to first end 22a of first segment 22 to ensure support stand 20 remains in the closed position. In various embodiments, the camera case is secured for efficient portability and storage.

In various embodiments, support stand 20 is moveable from the closed position to the open position by moving first segment 22 relative to second segment 24, wherein first segment 22 moves from about 90° away from the line 30 normal to surface 28 to in the range of about 20° to about 22.5° away from the line 30 normal to surface 28. In various embodiments, second segment 24 remains about 90° away from the line 30 normal to surface 28 and rests on surface 28.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “about” can, in some embodiments, mean within plus or minus ten percent of the stated value. In other embodiments, “about” can mean within plus or minus five percent of the stated value. In further embodiments, “about” can mean within plus or minus three percent of the stated value. In yet other embodiments, “about” can mean within plus or minus one percent of the stated value. As defined herein, any reference to attached, fixed, connected, coupled or the like may include permanent, removable, temporary, partial, full and/or any other possible attachment option.

In the following detailed description of the embodiments, reference is made to the accompanying drawings which form a part hereof, and in which are shown by way of illustrations. Further, features of the various described embodiments may be combined, other embodiments may be utilized, and structural changes may be made without departing from the scope of the present disclosure.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in certain embodiments structural and functional elements within the FIGS. may be combined, separated, or removed, without departing from the scope of the disclosure. As another example, functionality assigned to a particular element or module may be handled by another element instead or various functions may be combined into a single element or application. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced.

Accordingly, the disclosure and the figures are to be regarded as illustrative and not restrictive.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

We claim:

1. A camera case comprising:
a support stand comprising a first segment and a second segment, wherein the first segment and the second segment are hingedly coupled;
a housing coupled to a first surface of the first segment, wherein the housing is configured to hold a camera; and
wherein the support stand is moveable from a closed position to an open position by rotating the first segment relative to the second segment,
wherein the rotating is from a first position to a second position, wherein the second position is in a range of about 20° to about 22.5° away from a line normal to a surface, and wherein, when in the open position, the second segment is configured to rest on the surface.

2. The camera case of claim 1, wherein the camera comprises a mobile electronic device.

3. The camera case of claim 1, wherein the first segment further comprises a first end and a second end, wherein the second end terminates in a concave flange configured to securely brace the housing.

4. The camera case of claim 1, wherein the second segment further comprises a first end and a second end, wherein the first end terminates in a hook configured to removably fasten to the first end of the first segment when the support stand is in the closed position.

5. The camera case of claim 1, wherein the first position is at about 90° away from the line normal to the surface.

6. The camera case of claim 1, wherein, when the support stand is in the open position, the camera captures a perspective angle of an object.

7. The camera case of claim 6, wherein the object is a vehicle.

8. The camera case of claim 7, wherein the perspective angle is an underbody angle of the vehicle.

9. A method for using a camera case comprising:
moving a support stand from a closed position to an open position,
wherein the support stand comprises:
a first segment hingedly coupled to a second segment,
wherein the first segment is configured to move relative to the second segment to achieve the open position from the closed position, and
wherein, when the support stand is in the open position, the first segment is in a range of about 20° to about 22.5° away from a line normal to a surface and the second segment rests on the surface;
placing a camera into a housing, wherein the housing is coupled to a first surface of the first segment; and
capturing a perspective angle of an object via the camera.

10. The method of claim 9, wherein the camera comprises a mobile electronic device.

11. The method of claim 9, wherein the first segment further comprises a first end and a second end, and wherein the second end terminates in a concave flange configured to securely brace the housing.

12. The method of claim 9, wherein the second segment further comprises a first end and a second end, and wherein the first end terminates in a hook configured to removably fasten to the first end of the first segment when the support stand is in the closed position.

13. The method of claim 9, wherein the object is a vehicle.

14. The method of claim 13, wherein the perspective angle is an underbody angle of the vehicle.

15. A method of constructing a camera case comprising:
hingedly coupling a first segment of a support stand to a second segment of the support stand,
wherein the first segment is configured to rotate relative to the second segment to move between a closed position of the support stand and an open position of the support stand, and
wherein when the support stand is in the open position, the first segment is in a range of about 20° to about 22.5° away from a line normal to a surface and the second segment rests on the surface; and
coupling a housing to a first surface of the first segment,
wherein the housing is configured to hold a camera.

16. The method of claim 15, wherein the camera comprises a mobile electronic device.

17. The method of claim 15, wherein the first segment further comprises a first end and a second end, and wherein the second end terminates in a concave flange configured to securely brace the housing.

18. The method of claim 15, wherein the second segment further comprises a first end and a second end, and wherein the first end terminates in a hook configured to removably fasten to the first end of the first segment when the support stand is in the closed position.

19. The method of claim 15, wherein when the support stand is in the open position, the camera is angled to capture a perspective angle of an object.

20. The method of claim 19, wherein the object is a vehicle, and the perspective angle is an underbody angle.
